(19) United States
(12) Patent Application Publication
(10) Pub. No.: US 2008/0176084 A1
(43) Pub. Date: Jul. 24, 2008

(54) Defrost glass

(76) Inventor: Shu-Lien Chen, Taichung (TW)

Correspondence Address: Shu-Lien Chen, P.O. BOX 55-124, TAICHUNG, omitted

(21) Appl. No.: 11/655,989

(22) Filed: Jan. 22, 2007

(51) Int. Cl. B32B 17/06

(52) U.S. Cl. 428/426

(57) ABSTRACT

A defrost glass includes two glass plates and two films are attached to two respective facing sides of the two glass plates. A heating layer is clamped between the two glass plates and located between the two films. The heating layer includes a transparent base board with a heating film attached on one side of the base board. The heating film is made by Indium Tin Oxide. Two adhering strips are connected on two ends of the heating film and electrically connected with a wire. The heating film generates heat to remove the condensed water on the defrost glass when current passes through the heating film.

### FIELD OF THE INVENTION

The present invention relates to a defrost glass which includes two glass plates with a transparent heating layer clamped therebetween so as to prevent condensation of mist on the glass plates.

### BACKGROUND OF THE INVENTION

A conventional defrost mirror used for back mirror of vehicles generally includes a base board which is made by transparent plastic material and heating wires made by copper alloy are attached on the base board so that when current passes through the heating wires, the resistance of the wires generates to remove the mist, for or even ice condensed on the back mirror. However, in order not to impede the driver to see clearly from the back mirror, the heating wires have to be attached on the back mirror in a low density way which means less number of the heating wires are attached on a certain area of the back mirror and the gaps between the heating wires are wide enough to allow the driver to see the cars follow. The less number of the heating wires require more time to remove the condensation on the back mirror and the temperature generated by the heating wires cannot be too high or the transparent plastic material might be whitened permanently.

The present invention intends to provide a defrost glass which includes a transparent heating layer made by Indium Tin Oxide (ITO hereinafter) and the heating later is clamped between two glass plates by two adhering strips. The transparent heating layer covers most area of the glass plates so that the driver can see from the back mirror clearly while no mist is formed on the area.

### SUMMARY OF THE INVENTION

The present invention relates to a defrost glass which includes two glass plates and two films are attached to two respective facing sides of the two glass plates. A heating layer is clamped between the two glass plates and located between the two films. The heating layer includes a transparent base board with a heating film made by Indium Tin Oxide is attached on one side of the base board. Two adhering strips are connected on two ends of the heating film and electrically connected with a wire.

The primary object of the present invention is to provide a defrost glass and the heating layer covers a larger area of the glass plates so as to provide a large clear area.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the defrost glass of the present invention;

FIG. 2 shows the cross sectional view of the defrost glass of the present invention;

FIG. 3 shows two adhering strips located on two ends of the heating film of the defrost glass of the present invention, and

FIG. 4 shows another embodiment of the defrost glass of the present invention.

### DETAILED DESCRIPTION OF THE PREFERRED EMBODIMENT

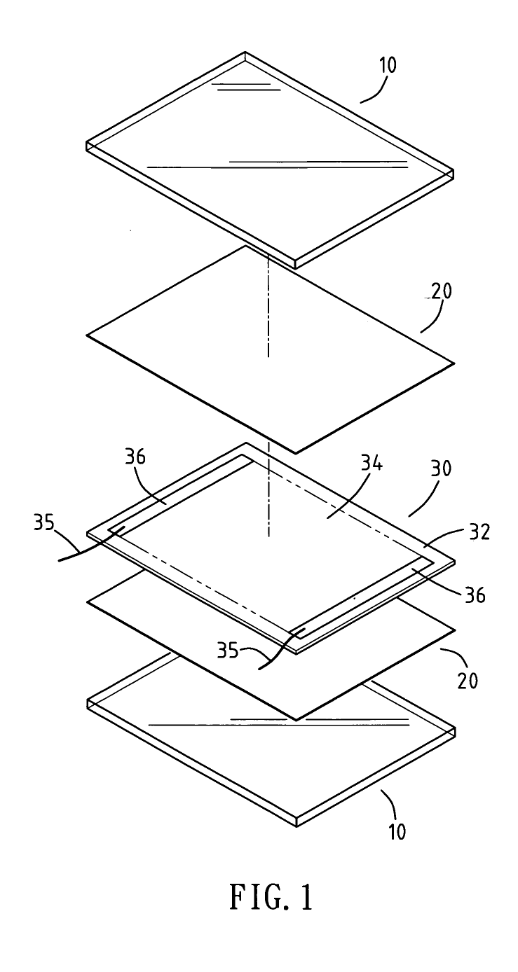

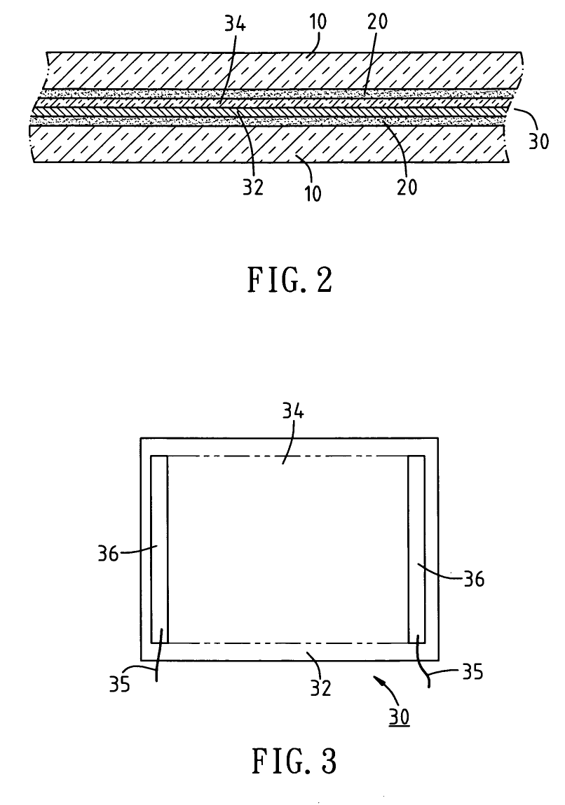

Referring to FIGS. 1 to 3, the defrost glass of the present invention comprises two glass plates 10 and two films 20 are attached to two respective sides of the two glass plates 10 and the two respective sides face toward each other. A heating layer 30 is clamped between the two glass plates 10 and located between the two films 20. The heating layer 30 includes a transparent base board 32 and a heating film 34 is attached on the base board 32. The base board 32 can be made by glass or Polyethylene, preferably, made by transparent and heat-isolation material so as to avoid heat from transferring to the opposite side of each of the glass plates 10. The heating film 34 is made by Indium Tin Oxide (ITO). Two adhering strips 36 are connected on two ends of the heating film 34 and are made by copper alloy and electrically connected with a wire 35. The two adhering strips 36 each are a conductive strip and located in parallel to each other.

Because the heating film 34 and the base board 32 are transparent and cover a large area of the glass plates 10 so that when current passes through the heating film 34, the temperature caused by resistance can remove the condensed mist, fog or ice on a large area on the glass plates 10. Therefore, the defrost glass is suitable for back mirror of vehicles. The defrost glass of the present invention can also be used as mirrors in bath rooms, or surfaces of TFT monitors.

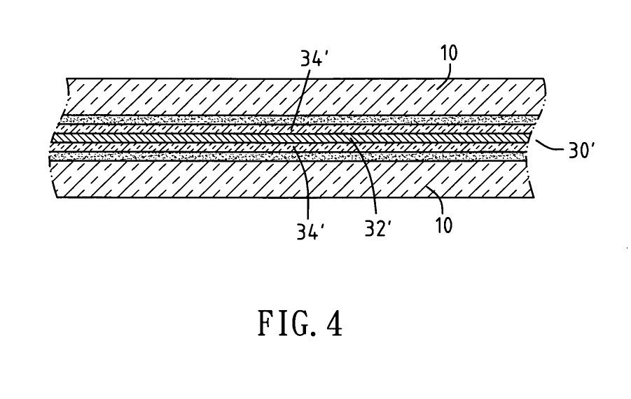

As shown in FIG. 4, another embodiment of the defrost glass of the present invention includes glass plates 10 and the heating layer 30′ is located between the two glass plates 10. The heating layer 30′ includes two heating films 34′ which are attached on two opposite sides of the base board 32′ by four adhering strips (not shown). By the defrost glass, the two opposite sides of the base aboard 32′ generate heat to remove mist, fog and ice condensed on the defrost glass.

While we have shown and described the embodiment in accordance with the present invention, it should be clear to those skilled in the art that further embodiments may be made without departing from the scope of the present invention.

What is claimed is:

1. A defrost glass comprising:
two glass plates;
two films attached to two respective sides of the two glass plates and the two respective sides facing toward each other, and
a heating layer clamped between the two glass plates and located between the two films, the heating layer including a transparent base board and a heating film attached on the base board, the heating film being made by Indium Tin Oxide, two adhering strips connected on two ends of the heating film and electrically connected with a wire.

2. The defrost glass as claimed in claim 1, wherein the two adhering strips each are a conductive strip and located in parallel to each other.

3. The defrost glass as claimed in claim 1, wherein the base board is made by transparent and heat-isolation material.

4. The defrost glass as claimed in claim 1, wherein the heating layer includes two heating films which are attached on two opposite sides of the base board.
